(19) United States
(12) Patent Application Publication
(10) Pub. No.: US 2012/0205570 A1
(43) Pub. Date: Aug. 16, 2012

(54) VALVE FOR INTERRUPTING A FLOW PATH IN A SUBSTANTIALLY GAS-TIGHT MANNER

(75) Inventor: Michael Lamprecht, Maeder (AT)

(73) Assignee: VAT HOLDING AG, Seelistrasse (CH)

(21) Appl. No.: 13/391,266

(22) PCT Filed: Jul. 21, 2010
(86) PCT No.: PCT/EP2010/060566

§ 371 Date: May 1, 2012

(30) Foreign Application Priority Data
Aug. 19, 2009 (EP) 09168142.9

(51) Int. Cl. F16K 1/42

(52) U.S. Cl. 251/359

(57) ABSTRACT

The invention relates to a valve for interrupting a flow path in a gas-tight manner. The valve has a valve housing, a valve plate, and a drive by means of which the valve plate can be shifted between an open position and a closed position. According to the invention, the valve has a seal support which, in a coupling position, can be coupled to and decoupled from a first seat of the valve plate on the latter and, in a parked position, can be coupled to and uncoupled from a second seat of a parking section in said section of the valve housing. A first seal is arranged on the seal support such that the first seal contacts a valve seat in a gas-tight manner in the coupling position and in the closed position, a gas-tight connection being formed between the first seal and a closing surface that lies on the valve plate. The seal support can be detachably coupled to the first seat of the valve plate in the coupling position by means of first coupling means. The seal support can be detachably coupled to the second seat of the parking section in the parked position by means of second coupling means.

The invention relates to a valve for interrupting a flow path in a substantially gas-tight manner in accordance with the preamble of claim 1. Such valves, particularly in the form of pendulum valves or slide valves, are used primarily in vacuum technology.

Valves of the type mentioned in the introduction are known in various embodiments from the prior art and are used particularly in vacuum chamber systems in the area of IC, semiconductor or substrate manufacture, which has to take place in a protected atmosphere as far as possible in the absence of contaminating particles. Vacuum chamber systems of this kind comprise, in particular, at least one evacuatable vacuum chamber which is provided for receiving semiconductor elements or substrates to be processed or produced and which has at least one vacuum chamber opening through which the semiconductor elements or other substrates can be guided into and out of the vacuum chamber, and also at least one vacuum pump for evacuating the vacuum chamber. By way of example, in a manufacturing installation for semiconductor wafers or liquid crystal substrates, the highly sensitive semiconductor or liquid crystal elements sequentially pass through a plurality of process vacuum chambers, in which the parts situated within the process vacuum chambers are processed by means of a respective processing device. Both during the processing process within the process vacuum chambers and during transport from chamber to chamber, the highly sensitive semiconductor elements or substrates always have to be situated in a protected atmosphere—in particular in an evacuated environment.

For this purpose, use is made firstly of peripheral valves for opening and closing a gas supply or discharge, and secondly of transfer valves for opening and closing the transfer openings of the vacuum chambers for guiding the parts in and out.

The vacuum valves traversed by semiconductor parts are designated as vacuum transfer valves on account of the described field of application and the associated dimensioning, also as rectangular valve on account of their rectangular opening cross section and also as slide valve, rectangular slide or transfer slide valve on account of their customary functioning.

Peripheral valves are used, in particular, for controlling or regulating the gas flow between a vacuum chamber and a vacuum pump or a further vacuum chamber. Peripheral valves are situated, for example, within a pipe system between a process vacuum chamber or a transfer chamber and a vacuum pump, the atmosphere or a further process vacuum chamber. The opening cross section of such valves, also called pump valves, is generally smaller than in the case of a vacuum transfer valve. Since peripheral valves, depending on the field of use, are used not only for completely opening and closing an opening, but also for controlling or regulating a throughflow by continuously adjusting the opening cross section between a fully open position and a gas-tight closed position, they are also designated as regulating valves. One possible peripheral valve for controlling of regulating the gas flow is the pendulum valve.

In a typical pendulum valve, as known for example from U.S. Pat. No. 6,089,537 (Olmsted), in a first step, a generally round valve plate is rotationally pivoted via a generally likewise round opening from a position that releases the opening into an intermediate position covering the opening. In the case of a slide valve, as described for example in U.S. Pat. No. 6,416,037 (Geiser) or U.S. Pat. No. 6,056,266 (Blecha), the valve plate, as well as the opening, is usually embodied in a rectangular manner and, in this first step, is pushed linearly from a position that releases the opening into an intermediate position covering the opening. In this intermediate position, the valve plate of the pendulum or slide valve is situated in a position spaced apart and opposite with respect to the valve seat surrounding the opening. In a second step, the distance between the valve plate and the valve seat is reduced, such that the valve plate and the valve seat are uniformly pressed onto one another and the opening is closed in a substantially gas-tight manner. This second movement is preferably effected substantially in a perpendicular direction with respect to the valve seat. The sealing can be effected e.g. either by means of a seal ring arranged on the closure side of the valve plate, said seal ring being pressed onto the valve seat circumferentially surrounding the opening, or by means of a seal ring on the valve seat, against which the closure side of the valve plate is pressed. By means of the closing operation effected in two steps, the sealing ring between the valve plate and the valve seat is subjected to hardly any shear forces that would destroy the sealing ring, since the movement of the valve plate in the second step takes place substantially rectilinearly perpendicularly to the valve seat.

The prior art discloses various drive systems for obtaining this combination of a movement—rotational in the case of the pendulum valve and translational in the case of the slide valve—of the valve plate parallel via the opening and a substantially translational movement perpendicular to the opening, for example from U.S. Pat. No. 6,089,537 (Olmsted) for a pendulum valve and from U.S. Pat. No. 6,416,037 (Geiser) for a slide valve.

U.S. 2007/0138424 (Geiser) and U.S. 2007/0138425 (Geiser) disclose a valve, in particular a pendulum or slide valve, for interrupting a flow path in a substantially gas-tight manner. The valve comprises a valve housing having a first wall, which has a first opening and a first valve seat, a valve plate having a closure side with a sealing ring and at least one drive. By means of the drive, the valve plate is pivotable or displaceable from an open position substantially parallel to the first valve seat and the perpendicular distance between the valve plate and the first valve seat can be reduced in such a way that, by means of an axially sealing contact between the sealing ring and the first valve seat, the flow path is interrupted in a substantially gas-tight manner in the closed position. The valve plate comprises an outer plate section, which is connected to the drive and fixes the sealing ring in a perpendicular direction with respect to the first valve seat, and an inner plate section, which has an outer circumferential surface and which is mounted in a movable manner relative to the outer plate section in a direction substantially perpendicular to the first valve seat. The outer circumferential surface is enclosed by the sealing ring in a substantially gas-tight internally sealing manner. Consequently, in the closed position, a pressure difference at the valve plate acts substantially on the inner plate section, such that the inner plate section, in a manner perpendicularly decoupled from the outer plate section, is supported on a section of the valve housing, in particular the first valve seat or a lateral groove.

Furthermore, slide valves are known in which the closing and sealing operation is effected by means of a single linear movement. These are described in diverse embodiments, for example: wedge valves or for example the transfer valve known by the product designation “MONOVAT Series 02 and 03” and configured as a rectangular insert valve from VAT Vakuumventile AG in Haag, Switzerland. The construction and the functioning of such a valve are described for example in U.S. Pat. No. 4,809,950 (Geiser) and U.S. Pat. No. 4,881,717 (Geiser).

Various sealing devices are described in the prior art, for example in U.S. Pat. No. 6,629,682 B2 (Duelli). A suitable material for seal rings is, for example, the elastic seal material known by the trade name Viton®.

A distinction should be drawn between dynamic seals and static seals on the vacuum valve.

Static seals do not participate directly in the operation of closing a valve in a gas-tight manner. They are situated, in particular, at the connections of the vacuum valve, that is to say for example between the vacuum valve connection and a vacuum device, e.g. a process chamber, a transport chamber, a vacuum pump or a pipeline system, to which the vacuum valve is connected. Static seals are generally subjected to a lower mechanical loading than dynamic seals, since, after the mounting of the vacuum valve on the vacuum device, the forces acting on the seal are substantially constant and the gas-tight contact after the vacuum valve has been mounted is maintained over a relatively long period of time. Moreover, they are exposed less to the—possibly aggressive—medium flowing through in the interior of the valve housing. Chemical and abrasive influences on static seals are generally smaller than in the case of dynamic seals.

Dynamic seals serve, in particular, for gas-tight sealing between the valve seat and the movable valve closure, for example the valve plate. Upon actuation of the valve and gas-tight closing and opening again, dynamic seals are exposed to a dynamic loading and are thus necessarily subjected to a certain mechanical wear. Moreover, dynamic seals are exposed to the medium that flows through the valve to a significant extent. This is the case primarily in intermediate positions of the valve closure, since in this case the medium flows directly past the dynamic seal. In order to protect the dynamic seal with the valve closure fully open and in order not to expose it directly to the throughflow of the medium, vacuum valves known from the prior art provide in part at least partly protected regions in the valve housing in which the valve closure in its fully open position is pivoted out of the direct throughflow region. However, if such a valve is operated in a position in which the valve closure is situated in an intermediate position between the fully open position and the gas-tight closed position, such that the open cross section is only reduced, the dynamic seal is necessarily exposed to the medium flowing through the valve, as a result of which increased wear of the dynamic seal occurs on account of chemical effects and on account of abrasion.

Numerous processes make use of aggressive gases—for example an aggressive plasma stream—which chemically attack the sealing material to a considerable extent. Particularly in etching processes or coating processes in the field of the semiconductor industry, the flow of an aggressive gas through the process vacuum chamber in which the etching or coating process takes place is regulated by means of a peripheral valve. A pendulum valve is preferably used as peripheral valve. The throughflow of the aggressive gas is regulated by the opening cross section of the valve being reduced and enlarged. During the processing process in which the valve is in this regulating mode, although the valve is regularly adjusted, it is not necessary for the valve to be completely closed. Since the valve plate with the seal thereof always projects into the opening cross section of the valve in the intermediate positions between the open position and the closed position and the aggressive gas flows past the valve plate and the seal thereof, both the valve plate and the seal thereof are strongly chemically influenced by the aggressive gas in this regulating mode. Whereas in processes of this type the regulating mode makes up approximately 95% of the use time of the valve, the closing mode forms only 5% of the time proportion. In this case, the gas-tight closing only has to be effected during service and cleaning work. Investigations have shown that in processes in the field of IC, semiconductor or substrate manufacture in which peripheral valves used for regulation are employed, the ratio of the regulating cycles of the valve to the closing cycles is approximately 2 000 000 to 50. The proportion of the cycles in which the valve is therefore not used for gas-tight closing, but rather for reducing and enlarging the valve opening cross section thus drastically predominates. Despite the only occasional use of the dynamic seal and although the seal has been exposed to no or hardly any mechanical loading by the closing of the valve, it thus has to be exchanged at regular intervals on account of these chemical attacks. Depending on the process, the dynamic seal has to be exchanged weekly. This costs time and leads to an interruption of the manufacturing process.

As a result of progress in semiconductor technology, the requirements made of vacuum valve technology have also risen continuously in recent years. New semiconductor manufacturing methods thus require the seals of a vacuum valve to be exchanged at even shorter intervals. The vacuum valves previously known from the prior art partly enable the seal to be exchanged, for example by exchanging the O-ring embodied as a static seal. However, vacuum valves whose connections have vulcanized static seals make it impossible to exchange the seal quickly, with the result that the entire valve plate has to be exchanged in some instances.

For this reason, vacuum valves of the stated type are regularly constructed in such a way that simple exchange of the dynamic seal is possible, for example by the removal of the valve plate on which the seal is arranged, and the replacement of the valve plate by a new valve plate. A vacuum slide valve which is designed for this purpose and which provides a maintenance opening for simple removal of the valve plate and an interface—suitable for rapid exchange—between the valve plate and the push rod of the valve drive, and also an appropriate multifunctional tool are described in U.S. Pat. No. 7,134,642 (Seitz).

However, even relatively fast and simple exchange of the seal or seals or of the entire valve closure requires an interruption of the process, under certain circumstances flooding of the chambers with ambient air and the use of replacement parts. It would be desirable to increase the lifetime of the seals and thus to increase the maintenance and exchange intervals.

Therefore, one object of the invention is to provide a valve for interrupting a flow path in a substantially gas-tight manner, the dynamic seal of said valve having an increased lifetime.

A further object of the invention is to improve the described valves known from the prior art in such a way that the lifetime of the dynamic seal of the valve is increased.

A further object of the invention is to provide a valve whose dynamic seal, in the open position and in the intermediate position of the valve plate, is attacked only to a limited extent, or is not attacked at all, by the medium flowing through the valve.

These objects are achieved by the realization of the characterizing features of the independent patent claim. Features that develop the invention in an alternative or advantageous manner can be gathered from the dependent patent claims.

The invention is based on providing a seal carrier, which can be coupled to, and decoupled from again, the valve plate and a parking section of the valve housing. In order to be able to close the valve opening in a gas-tight manner by means of the valve plate, the seal carrier with its first seal, which serves as a dynamic seal, is arranged in the so-called coupling position on the valve plate, such that the valve plate with the first seal can be pressed onto the valve seat for the purpose of closing the valve opening in a gas-tight manner. By contrast, if gas-tight closing by means of the valve plate is not required, rather the cross section of the valve opening is intended only to be reduced and the flow path is intended only to be partly interrupted, the seal carrier with the first seal can be decoupled from the valve plate and coupled to the parking section of the valve housing in the so-called parked position. If the seal carrier is situated in said parked position, the dynamic first seal is protected against the medium flowing through the valve. The valve plate decoupled from the seal carrier and the first seal can then be used for regulating the throughflow by at least partly covering the cross section of the valve opening and thus by reducing and enlarging the opening cross section, wherein the first seal is not directly exposed to the medium flowing through the valve.

The valve according to the invention can thus be operated in two operating modes, namely a first operating mode for reducing and enlarging the opening cross section, wherein gas-tight closing is not effected, and a second operating mode for complete gas-tight closing of the valve. Since, in the first operating mode, in which the seal carrier is situated in the parked position, the first seal is not exposed to the throughflow of the medium, in this operating mode the first seal is subject to no or hardly any chemical or abrasive wear caused by the medium flowing through. Particularly in fields of application in which the first operating mode, that is to say the regulating mode, is predominant and the second operating mode for closing the valve in a gas-tight manner is chosen only occasionally, in particular for maintenance purposes, the lifetime of the first seal is considerably increased. The valve according to the invention is thus distinguished, depending on the proportions of the operating modes, by a significantly longer lifetime of the dynamic seal and thus by significantly longer maintenance intervals. The maintenance-dictated outage times of the installation in which the valve according to the invention is used can thus be drastically reduced. Chemical influencing of the process by the presence of a sealing material and generation of abrasion particles of the dynamic seal in the regulating mode can be completely avoided by means of the valve according to the invention.

The valve according to the invention for interrupting a flow path in a substantially gas-tight manner has a valve housing, in which at least one valve opening for the flow path is provided. The flow path should generally be understood to mean an opening path to be closed between two regions—in particular between a process chamber for semiconductor manufacture and a peripheral device such as a pump, a further process chamber or the outside world. The flow path is, for example, a connecting passage between a process chamber and a pump or two process chambers connected to one another. The valve can be, in particular, a peripheral valve, for example a pendulum valve, for conveying gases through it, or a transfer valve for transferring semiconductor parts from one process chamber to the next or to the outside world. The last-mentioned valves are also designated as vacuum transfer valves on account of the field of application described, and also as rectangular slides on account of their usually rectangular opening cross section. It goes without saying, however, that any other desired application of the vacuum valve according to the invention for closing any desired flow path in a substantially gas-tight manner is also possible.

The valve opening has, for example, a substantially round, oval or rectangular cross section and has a central axis extending in the region of the valve opening in the center of the flow path parallel to the latter. This opening axis is, for example, perpendicular to the area spanned by the valve opening. The valve opening is enclosed by a valve seat extending all around the opening. By way of example, the surface of the valve seat faces at least partly in a direction parallel to the opening axis.

Moreover, the valve has an adjustable valve plate having a closure side and also at least one drive by means of which the valve plate can be adjusted between an open position and a closed position. The adjustment between the open position and the closed position is effected via the drive by means of a transverse movement effected at least partly transversely with respect to the opening axis. In other words, the valve plate is pivotable or displaceable by means of the drive in at least one direction having at least one direction component perpendicular to the opening axis. In one possible embodiment, said direction component is parallel to the area spanned by the valve seat and the movement is effected at least partly parallel to the valve seat, provided that the latter extends perpendicular to the opening axis. However, the invention encompasses not only a valve having a uniaxial drive, by means of which the valve plate can be moved along one axis or about one axis, but preferably also multiaxial drives, by means of which the valve plate can also be moved along at least one or about at least one second axis.

The closure side of the valve plate is that side which, in the closed position of the valve plate, faces the valve opening, and in particular the valve seat. In the open position, the valve plate is positioned in a parking section of the valve housing, said parking section being arranged laterally alongside the valve opening. The parking section is generally that region of the valve in which the valve plate moved from the opening cross section is situated alongside the opening. The valve opening and the flow path are released in the open position. The valve is fully open in the open position. In the closed position, the valve plate covers the valve opening with a closing surface arranged on the closure side. The closing surface is any desired, in particular, disk-, plate- or sheet-like element or segment by means of which the cross section of the valve opening can be at least partly covered. The closing surface is either fixedly connected to the valve plate and forms a constituent part of the valve plate which extends on the closure side, or it is mounted movably—in particular in a direction parallel to the opening axis, on the closure plate, or it can be decoupled from the valve plate. In the closed position, a first seal, which acts as a dynamic seal, touches the valve seat in a gas-sealing manner, such that there is a gas-tight contact between the first seal and the valve seat. The valve plate closes the valve opening in a gas-tight manner, such that the flow path is interrupted.

According to the invention, the valve has a seal carrier, which can assume at least two typical positions. In the first position the seal carrier is coupled to the valve plate, and in the second position it is coupled to the parking section, that is to say arranged there in each case mechanically releasably, in a temporarily fixed manner.

The first position is designated as the coupling position. In the coupling position of the seal carrier, the latter is coupled to a first receptacle of the valve plate on the valve plate. The first receptacle is generally an element or a section on the valve plate by means of which a connection between the seal carrier and the valve plate can be produced. In order to fix this connection in a releasable manner, the valve has first coupling means, by means of which the seal carrier can be releasably coupled to the first receptacle of the valve plate and thus fixed in the coupling position. The first receptacle and first coupling means should be understood functionally. It is possible for the first receptacle and the first coupling means to be embodied as a common mechanical element, wherein the first receptacle and the coupling means are both arranged on the valve plate. Alternatively, however, there is also the possibility of arranging the first receptacle on the valve plate for receiving the seal carrier, whereas the first coupling means, for example a spring-loaded latch, can be situated on the seal carrier and/or on the valve plate.

The second position is designated as the parked position. In this parked position of the seal carrier, the latter is coupled to a second receptacle of the parking section in the parking section of the valve housing. The second receptacle is an element or a section in the parking section on the valve housing by means of which a connection between the seal carrier and the valve housing can be produced. In order to be able to fix the seal carrier received in the second receptacle in the parking section, the valve has second coupling means, by means of which the seal carrier can be releasably coupled to the second receptacle of the parking section and thus fixed in the parked position. The terms second receptacle and second coupling means should also be understood functionally, since the second receptacle and the second coupling means can be formed by one functional unit or a plurality of functional units.

According to the invention, the first seal acting as a dynamic seal is arranged on the seal carrier in such a way that the first seal touches the valve seat in a gas-sealing manner if the seal carrier is situated on the valve plate and thus in the coupling position and if the valve plate has been moved into the closed position by means of the drive. Consequently, in the coupling position and in the simultaneous closed position, there is a gas-tight connection between the first seal and the valve seat. Moreover, the first seal is arranged on the seal carrier and the seal carrier and the closing surface are embodied in such a way that, in said coupling position and in the simultaneous closed position, there is a gas-tight connection between the first seal and the closing surface. In other words, in said closed position, there is a direct gas-tight contact between the valve seat and the first seal and also a direct or an indirect contact between the first seal and the self-contained closing surface.

A direct contact between the first seal and the closing surface can be brought about, for example, by virtue of the fact that the closing surface is arranged on the seal carrier and there is thus a gas-tight contact between the first seal and the closing surface on the seal carrier. It is possible for the first seal to be arranged directly on the closing surface, by the first seal being, for example, vulcanized on said closing surface or fixed in a groove on the closing surface. If the closing surface is a constituent part of the seal carrier, the gas-tight sealing of the valve opening and the interruption of the flow path are brought about by the seal carrier with the closing surface thereof, which covers the valve opening in the closed position, and with the first seal thereof, which bears on the valve seat in a gas-tight manner. A seal carrier equipped with the closing surface has, in particular, a disk-, plate- or sheet-like and a really self-contained form, such that it can serve as a closure for the valve opening.

An indirect contact between the first seal and the closing surface can be brought about, for example, by virtue of the fact that the closing surface is not a constituent part of the seal carrier, but rather is arranged fixedly or movably on the valve plate. In this case, the valve has sealing means which connect the seal carrier and the closing surface in a gas-sealing manner in the coupling position and in the closed position. For this purpose, in one possible embodiment, the sealing means are arranged on an at least partly radially inwardly facing inner surface of the, in particular ring-shaped, seal carrier in such a way that the sealing means, in the coupling position, enclose an at least partly radially outwardly facing outer surface of the closing surface in a substantially radially gas-sealing manner. Said closing surface can be arranged fixedly on the valve plate and have, in particular, a disk-like form having a radially outwardly facing boundary acting as the outer surface of the closing surface. Alternatively, however, the closing surface is arranged movably on the valve plate. In one possible embodiment, the closing surface is mounted on the valve plate in a movable manner in a direction perpendicular to the closure side relative to the valve plate and in the coupling position relative to the seal carrier within a movement range. In particular, the mounting is effected resiliently, such that the closing surface in the unloaded state is held in an initial position within the movement range. The movable mounting of the closing surface makes it possible that the closing surface can be supported directly on the valve seat or on some other section of the valve housing in the case of an excess or reduced pressure on one of the valve sides. Such mobility of a closing surface is known for example from U.S. 2007/0138424 (Geiser). In order that the gas-tight contact between the outer surface of the closing surface and the sealing means is ensured at least in a partial range of said movement range, the outer surface of the closing surface is dimensioned in such a way that, at least within a partial range of the movement range of the closing surface, it is enclosed in a gas-sealing manner be the sealing means in the coupling position. By way of example, the outer surface is dimensioned in a direction perpendicular to the closure side at least in accordance with the movement range.

Said sealing means can be formed by a second seal, which is arranged on an at least partly radially inwardly facing inner surface of the seal carrier and faces at least partly inwardly in a radial direction. In the coupling position, said second seal thus encloses an at least partly radially outwardly facing outer surface of the closing surface in a substantially radially gas-sealing manner. Said second seal can be, for example, an O-ring arranged in a circumferential groove, some other sealing ring or a vulcanized seal.

Alternatively, said sealing means are formed by the first seal. In this case, the first seal has two seal functions. For this purpose, the first seal is arranged in an inner edge section of an at least partly radially inwardly facing inner surface of the seal carrier and touches the valve seat in a gas-sealing manner with a partial section facing in an axial direction in the closed position of the valve plate. This seal function corresponds to the customary dynamic seal, as already described above. On account of the arrangement in the edge section, however, the first seal also encloses, with a partial section facing inwardly at least partly in a radial direction, in the coupling position, an at least partly radially outwardly facing outer surface of the closing surface in a substantially radially gas-sealing manner.

Radially should generally be understood to mean a direction component which runs substantially in a plane parallel to the closure side, wherein said planes is intersected in particular perpendicularly by the opening axis, whereas axially is generally understood to mean a direction component perpendicular to the closure side and, in particular, parallel to the opening axis. The term radially within the scope of the invention is not necessarily related to a circular cross section, but rather can also relate to a rectangular, oval or other cross section.

In one specific development of the invention, the closing surface is arranged on the valve plate, and the valve has sealing means, which connect the seal carrier and the closing surface in a gas-sealing manner in the coupling position and in the closed position. The sealing means are arranged on an at least partly radially inwardly facing inner surface of the seal carrier in such a way that the sealing means, in the coupling position, enclose an at least partly radially outwardly facing outer surface of the closing surface in a substantially radially gas-sealing manner, as already described above. The sealing means can be formed by the first seal or a second seal, as described above. In this embodiment, however, the at least partly radially outwardly facing outer surface of the closing surface serves as the first receptacle of the valve plate. In this embodiment, the first coupling means are formed by force-locking first coupling means in the form of the sealing means, which are elastic in a radial direction. The sealing means enclose the outer surface of the closing surface in the coupling position elastically in such a way that the seal carrier can be releasably fixed in the coupling position in a force-locking manner. In other words, in this embodiment, the sealing means have not only a sealing function, but also a coupling function in the sense of the first coupling means.

In one embodiment of the invention, the first coupling means, the first receptacle, the second coupling means and the second receptacle are embodied in such a way that the coupling of the seal carrier in the coupling position and the parked position and the decoupling are effected by movement of the valve plate by means of the drive. In other words, the valve plate can be moved by means of the drive in such a way that the seal carrier can be brought from its coupling position on the valve plate into its parked position in the parking section, and vice versa. For this purpose, by way of example, the drive is embodied in such a way that the valve plate can be moved at least in the open position in the form of a perpendicular movement in a direction perpendicular to the closure side. The coupling and decoupling of the seal carrier into and out of the coupling position and parked position are at least partly effected by the perpendicular movement. In other words, the drive is not just uniaxial, such that the valve plate can be moved along one axis or about one axis, but rather multiaxial, such that the valve plate can also be moved along at least one or about at least one second axis, namely in the form of a perpendicular movement in a direction perpendicular to the closure side. Such drives are customary in the case of slide or pendulum valves and are known from the prior art, since the perpendicular movement is used for perpendicularly pressing the dynamic seal onto the valve seat. In a further development of the invention, the second receptacle of the parking section is embodied in such a way that the seal carrier can be guided at least partly by this perpendicular movement into the second receptacle into the parked position and from the second receptacle out of the parked position. By way of example, the second coupling means are embodied as a bayonet catch having at least one slot having a lead-in and at least one knob. The bayonet catch is arranged and embodied in such a way that the knob, by means of the drive, can be introduced by the perpendicular movement into the lead-in and can be guided by the transverse movement into the slot and thus into the parked position.

In one specific embodiment, the first receptacle of the valve plate is embodied as a translational first receptacle, wherein the seal carrier can be guided by the perpendicular movement into the first receptacle into the coupling position and from the first receptacle out of the coupling position. In other words, the translational first receptacle and the first coupling means are embodied for receiving the seal carrier by means of a substantially rectilinear perpendicular movement running in a direction perpendicular to the closure side and, in particular, parallel to the opening axis. In one development of this embodiment, the first coupling means are embodied as force-locking first coupling means, which hold the seal carrier in the first receptacle in the coupling position with a holding force until the holding force is overcome. The holding is effected by frictional locking, in particular. The holding force is dimensioned in such a way that it can be overcome by the perpendicular movement out of the receptacle for the purpose of decoupling and into the receptacle for the purpose of coupling by means of the drive. By way of example, said force-locking first coupling means is embodied as a spring-loaded latch arranged in the seal carrier or in the first receptacle on the valve plate.

The invention is not restricted to any particular valve type. However, the invention has proved to be particularly advantageous in the form of a pendulum valve. In this case, the valve opening and the valve plate have, in particular, a substantially round cross section. The seal carrier has a ring-shaped or plate-shaped cross section. The transverse movement brought about by means of the drive is an, in particular arcuate, pivoting movement about a pivoting axis running substantially parallel to the opening axis. The perpendicular movement takes place in the form of a linear movement substantially parallel to the opening axis. The valve plate is pivotable by means of the drive between the open position and an intermediate position by the transverse movement. In said intermediate position, the valve plate with the closure side at least partly covers the valve opening and is arranged in a position spaced apart and opposite with respect to the valve seat. Consequently, in the intermediate position the valve plate reduces the valve opening and interrupts the flow path admittedly not yet completely, on account of the position spaced apart and opposite with respect to the valve seat, but indeed partly. The opening cross section of the valve is therefore—in particular significantly—reduced. Moreover, the drive is embodied in such a way that the valve plate is adjustable by means of the drive between said intermediate position and the closed position by the perpendicular movement. The basic construction of such a pendulum valve is described for example in U.S. 2007/0138424 (Geiser).

However, the valve according to the invention can also be embodied as a slide valve. In this case, the valve opening and the valve plate for example a substantially rectangular cross section. The seal carrier has a rectangularly frame-like or rectangularly closed cross section. The transverse movement of the drive is a linear movement along a, in particular rectilinear, pushing axis running substantially perpendicularly to the opening axis. The perpendicular movement is a linear movement substantially parallel to the opening axis. By means of the drive, the valve plate can be displaced between the open position and an intermediate position by the transverse movement. In the intermediate position, the valve plate with the closure side at least partly covers the valve opening and is arranged in a position spaced apart and opposite with respect to the valve seat. Consequently, the valve plate reduces the valve opening and interrupts the flow path partly, without completely interrupting it, since the valve plate is arranged in a position spaced apart and opposite with respect to the valve seat. Moreover, the valve plate is adjustable by means of the drive between the intermediate position and the closed position by the perpendicular movement.

According to the invention, however, the valve can also be a valve which can be closed by means of just a single transverse movement and which can be completely closed without a perpendicular movement, for example a wedge valve.

As a result of the decoupling of the seal carrier and thus of the first seal from the valve plate, the latter can be used for regulating, that is to say for reducing and enlarging the opening cross section, without the first seal, and if appropriate also the second seal, being directly exposed to the medium flowing through the valve. In order to completely partition the second seal from the medium, in one development the invention provides a protective surface in the parking section. This protective surface is shaped in such a way that the first seal is surrounded by the protective surface —in order to protect the first seal against the medium flowing along the flow path—in the parked position of the seal carrier. The protective surface has a groove-like form for example.

The valve according to the invention makes it possible to provide two different operating modes, namely a first operating mode for regulating the opening cross section of the valve, wherein the opening cross section can be completely opened and significantly reduced, in particular almost—but not in a gas-tight manner—closed, and a second operating mode, in which the valve can be completely opened and completely closed. The advantage of the first operating mode is that the dynamic first seal, in the parked position, is protected against chemical and mechanical influences and the lifetime of the first seal can thus be drastically increased.

In order to implement these operating modes, one embodiment of the invention comprises a control device, which is connected to the drive and embodied in such a way that the valve can be operated in the first operating mode and the second operating mode. In the first operating mode, the seal carrier is arranged in the parked position and the valve plate is adjustable between the open position and an intermediate position. In the intermediate position, the valve plate with the closure side at least partly covers the valve opening, is arranged in a position spaced apart and opposite with respect to the valve seat and reduces the valve opening, wherein the flow path is partly interrupted. In the second operating mode, the seal carrier is arranged in the coupling position and the valve plate is adjustable between the open position and the closed position. The operating modes are changed by adjustment of the drive in such a way that the seal carrier situated in the coupling position or parked position is retained by one of the coupling means in the respective receptacle. By way of example, the operating mode is changed by the introduction of a section of the seal carrier into the second receptacle, embodied as a bayonet catch, and into the second coupling means, embodied as a bayonet catch, by the pivoting of the valve plate into an undercut region of the bayonet catch and by perpendicular adjustment of the valve plate, such that the seal carrier is released from the valve plate by force-locking first coupling means being overcome. As a result of the seal carrier being released from the valve plate, it is thus arranged in the parking section in the parked position. The seal carrier can be brought from the parked position into the coupling position again by opposite movement of the valve plate.

The valve according to the invention is described in greater detail purely by way of example below on the basis of specific exemplary embodiments illustrated schematically in the drawings.

In detail:

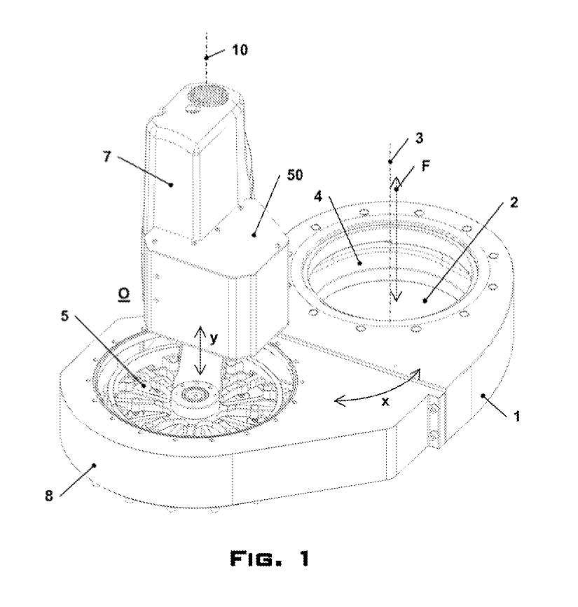

FIG. 1 shows an oblique view of a pendulum valve according to the invention in the open position;

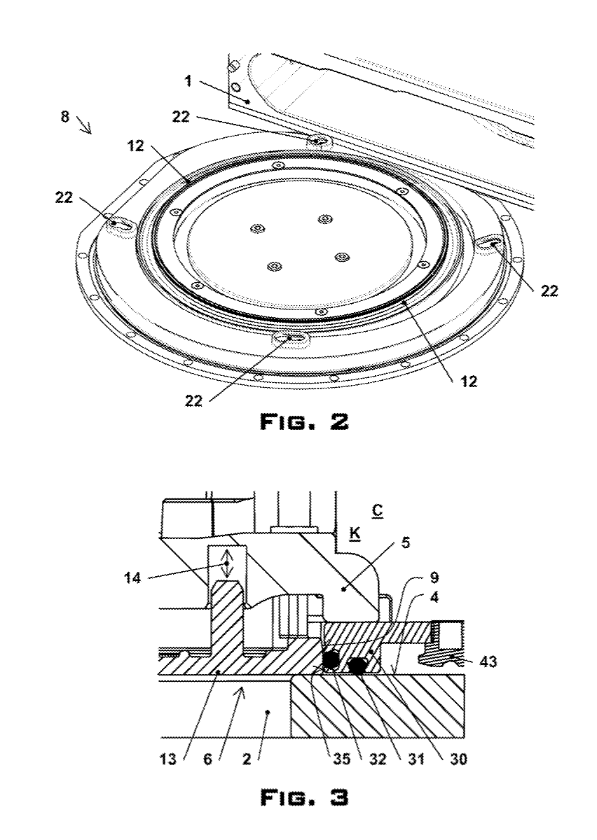

FIG. 2 shows a detailed oblique view of the parking section of the open valve housing;

FIG. 3 shows a lateral cross-sectional view of the valve plate in the closed position and the seal carrier in the coupling position;

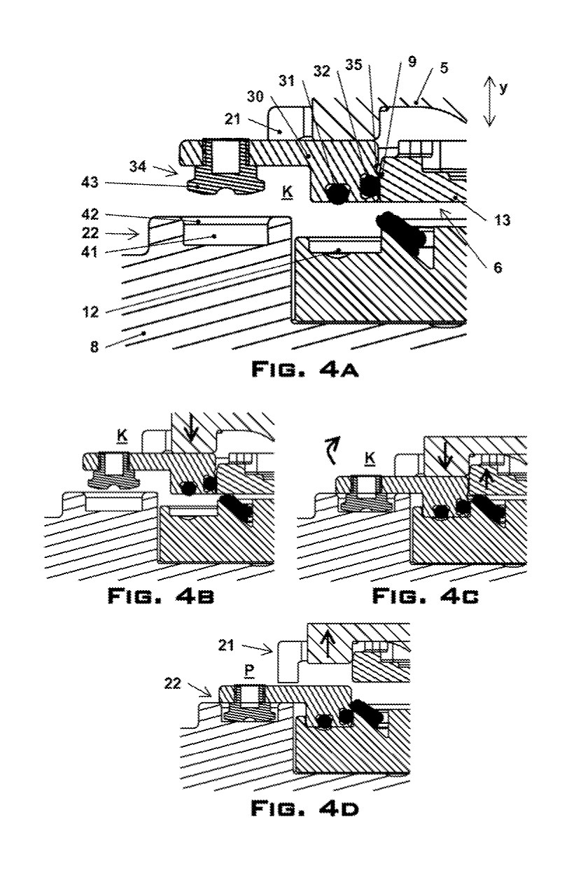

FIG. 4a shows a cross-sectional view of the valve plate in the parking section and the seal carrier in the coupling position;

FIG. 4b shows the cross-sectional view of the valve plate in the parking section and the seal carrier in the coupling position upon transition into the parked position;

FIG. 4c shows the cross-sectional view of the valve plate in the parking section and the seal carrier in the coupling position upon transition almost having been made into the parked position;

FIG. 4d shows the cross-sectional view of the valve plate in the parking section and the seal carrier after transition has been made into the parked position;

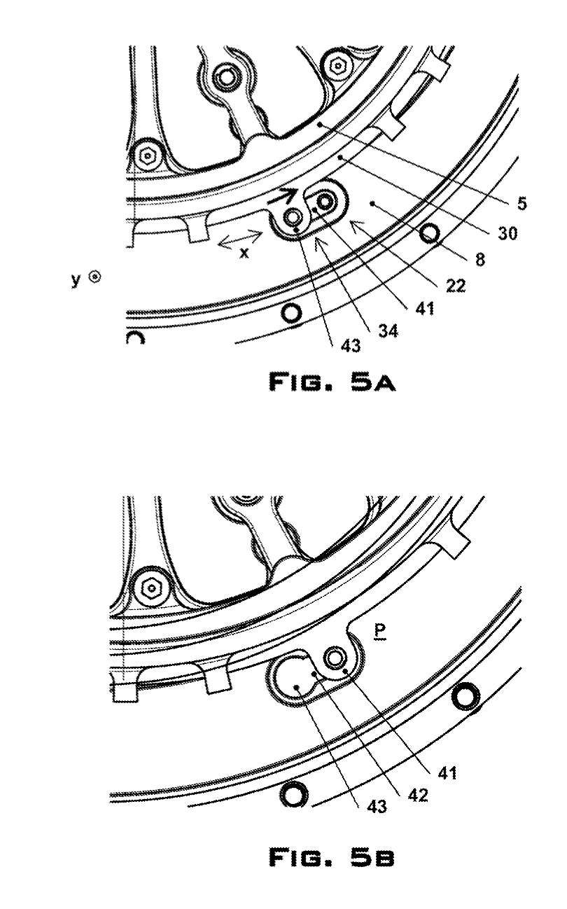

FIG. 5a shows a plan view of the parking section, the second receptacle and the seal carrier in the coupling position upon transition into the parked position;

FIG. 5b shows a plan view of the parking section, the second receptacle and the seal carrier in the coupling position after transition has been made into the parked position;

FIG. 6 shows a cross-sectional view of the first receptacle and the first coupling means embodied as a spring-loaded latch;

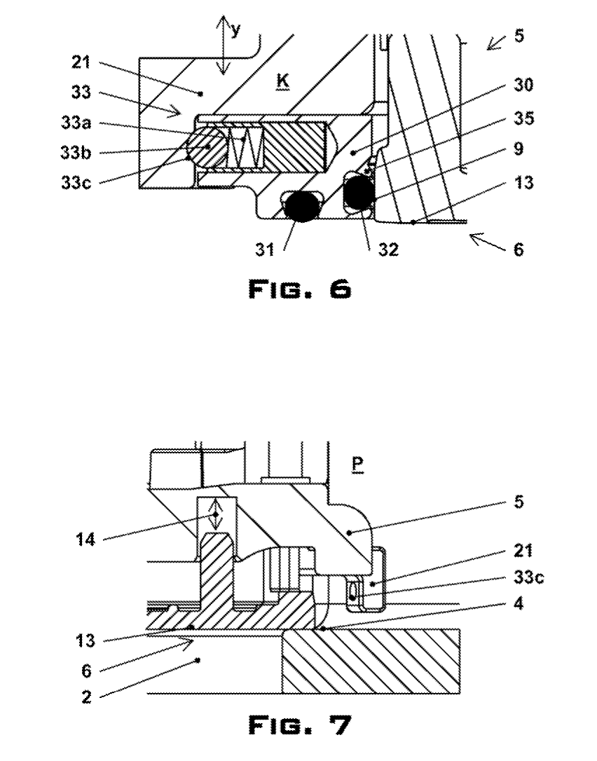

FIG. 7 shows a lateral cross-sectional view of the valve plate in an intermediate position without the seal carrier;

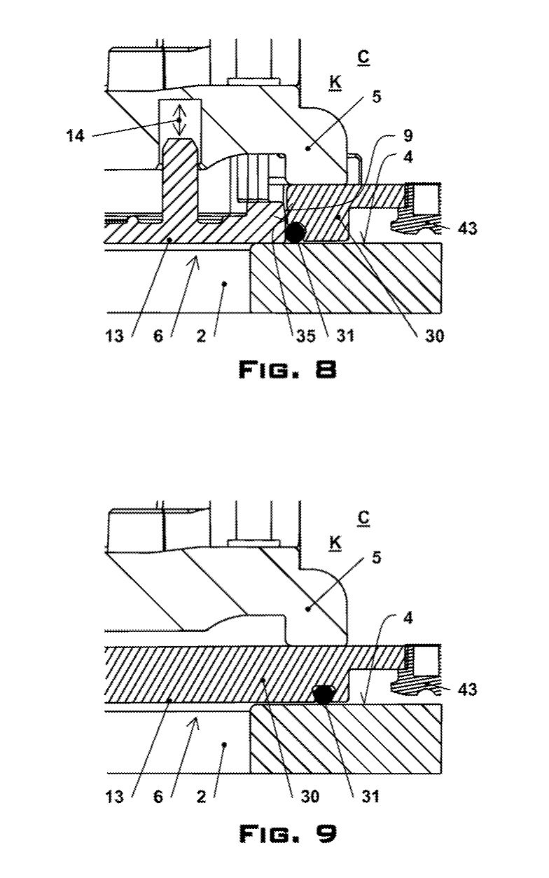

FIG. 8 shows a lateral cross-sectional view of the valve plate in the closed position and an alternative seal carrier having a single seal in the coupling position; and

FIG. 9 shows a lateral cross-sectional view of the valve plate in the closed position and an alternative seal carrier having a closed closing surface in the coupling position.

FIGS. 1, 2, 3, 4a, 4b, 4c, 4d, 5a, 5b, 6 and 7 show a common exemplary embodiment of a pendulum valve according to the invention in different states, from different views and in different degrees of detail. Therefore, these figures will be described jointly, in which case, in some instances, reference symbols and features that have already been explained in previous figures will not be discussed anew.

The valve illustrated in FIGS. 1 to 7 is embodied as a pendulum valve. The valve for interrupting a flow path F, illustrated in a symbolized manner in FIG. 1 by the arrow F, in a substantially gas-tight manner has a valve housing 1. A valve opening 2 for the flow path F is provided in said valve housing 1. The valve opening 2 has a substantially round cross section and extends straight through the valve housing 1 along a rectilinear opening axis 3, illustrated in FIG. 1 by the dash-dotted line 3. Even though the valve in the exemplary embodiment shown has two openings leading into the valve interior in the valve housing 1, namely an upper opening and a lower opening, only the lower opening is designated as the valve opening 2, since this valve opening 2 can be closed in a gas-tight manner. The valve opening 2 is enclosed by a valve seat 4, which is formed by a planar surface all around the valve opening 2. The plane of the valve seat 4 is intersected perpendicularly by the opening axis 3 in the exemplary embodiment shown.

A movable valve plate 5 having a substantially round cross section is arranged in the valve housing 1. As can be discerned in FIG. 1, the valve plate 5 has a strut-like basic structure and a pivoting arm, by means of which the valve plate is coupled to the drive 7. A closing surface 13 is arranged on the strut-like basic structure of the valve plate 5, as shown in FIG. 3. Said closing surface 13 faces downward in the orientation of the valve shown, that is to say in the direction toward the valve opening 2. This side is that side of the valve plate which serves for closing the valve opening 2, for which reason it is designated hereinafter as the closure side 6, illustrated in FIG. 3. The closing surface 13 is a closed, round sheet whose cross section is larger than the cross section of the valve opening 2, as can be discerned in FIG. 3. By means of the closing surface 13, therefore, the valve opening 2 can be completely covered, wherein the closing surface 13 bears on the valve seat 4, see FIG. 3. The closing surface 13 is mounted resiliently on the valve plate 5 in a movable manner in a direction perpendicular to the closure side 6 relative to the valve plate 5 within a movement range 14, illustrated by the arrow 14. The spring force acts downward, that is to say in the direction toward the valve seat 4 and toward the valve opening 2. This relative mobility of the closing surface 13 relative to the valve plate 5 makes it possible for the closing surface 13 to be supported on the valve seat 4 in the case of a relative excess pressure prevailing on the upper side, that is to say on the side of the valve plate 5 or on the side toward which the valve seat 4 faces. Consequently, a pressure difference of this type acts substantially on the closing surface 13 and the valve seat 4, but hardly on the rest of the valve plate 5 and the drive 7.

By means of the drive 7, shown in FIG. 1, the valve plate 5 is pivotable transversely with respect to the valve opening 2 and transversely with respect to the opening axis 3 in the form of a transverse movement x, which constitutes a pivoting movement, about a pivoting axis 10 running substantially parallel to the opening axis 3. Moreover, the valve plate 5 can be moved in the form of a perpendicular movement y in a direction perpendicular to the closure side 6 and perpendicular to the transverse movement x. The perpendicular movement y is a linear movement substantially parallel to the opening axis 3. The valve plate 5 can be adjusted by means of the drive 7 between an open position 0, shown in FIG. 1, and a closed position C, shown in FIG. 3. In the open position, the valve plate 5 is positioned in a parking section 8 of the valve housing 1, said parking section being arranged laterally alongside the valve opening 2. The valve opening 2 and the flow path F are released by the valve plate 5 and the closing surface 13 thereof. In the open position O, the closure plate is pivoted transversely out of the region of the valve opening 2, such that the opening cross section is completely released. The parking section 8 is an outwardly closed section in the interior of the valve housing 1, laterally alongside the valve opening 2, as shown in FIG. 1. For better illustration, the cover of the parking section 8 has been removed in FIG. 1, such that the valve plate can be discerned in its open position O in the parking section. In the operating state, however, the parking section is closed. In the closed position, shown in FIG. 3, the valve plate 5 covers the valve opening 2 with the closing surface 13 arranged on the closure side 6.

The valve has a ring-shaped seal carrier 30 having a basic form enclosing the closing surface 13, as shown in FIG. 3, which seal carrier can assume two typical positions, namely a coupling position K, FIG. 3 and FIG. 8, and a parked position P, FIGS. 4d and 5b. In the coupling position K, the seal carrier 30 is coupled to the valve plate 5, while in the parked position P of the seal carrier 30 it is coupled to the parking section 8 of the valve housing 1.

A first seal 31 acting as a dynamic seal is arranged on the seal carrier 30 in such a way that the first seal 31 touches the valve seat 4 in a gas-sealing manner in the coupling position K and in the closed position C, as shown in FIG. 3. In the coupling position K, there is a gas-tight connection between the first seal 31 and the closing surface 13 arranged on the valve plate 5. For this purpose, the valve has sealing means 32 which connect the seal carrier 30 and the closing surface 13 in a gas-sealing manner in the coupling position K. The sealing means 32 are arranged on an at least partly radially inwardly facing inner surface 35 of the seal carrier 30 in such a way that the sealing means 32, in the coupling position K, enclose a radially outwardly facing outer surface 9 of the closing surface 13 in a substantially radially gas-sealing manner, as shown in FIG. 3.

As already mentioned, the closing surface 13 is mounted on the valve plate 5 in a movable manner within a movement range 14. In order to ensure the gas-tight connection between the seal carrier 30 and the closing surface 13 in the coupling position K, the outer surface 9 of the closing surface 13 is dimensioned in such a way that it is enclosed in a gas-sealing manner by the sealing means 32 in the coupling position (K) at least within a partial range of the movement range 14 of the closing surface 13, as shown in FIG. 3.

Said sealing means 32 are formed by a ring-shaped second seal 32 in the exemplary embodiment in FIGS. 1 to 7. Said second seal 32 is arranged on a radially inwardly facing inner surface 35 of the seal carrier 30 and faces inwardly in a radial direction. The second seal 32, in the coupling position K, encloses the radially outwardly facing outer surface 9 of the closing surface 13 in a substantially radially gas-sealing manner, as shown in FIG. 3.

Instead of this embodiment comprising two seals 31 and 32 which is illustrated in FIG. 3, however, it is also possible for the sealing means to be formed by the first seal 31, as shown in an alternative embodiment in FIG. 8. FIG. 8 corresponds to FIG. 3. In this case, the first seal 31 has a dual function. For this purpose, the first seal 31 is arranged in an inner edge section of the at least partly radially inwardly facing inner surface 35 of the seal carrier 30. It touches the valve seat 4 in a gas-sealing manner with a partial section facing in an axial direction in the closed position C of the valve plate 5, as shown in FIG. 8. With the partial section facing inwardly at least partly in a radial direction, the first seal 31, in the coupling position K, encloses the at least partly radially outwardly facing outer surface 9 of the closing surface 13 in a substantially radially gas-sealing manner, as can likewise be discerned in FIG. 8.

The exemplary embodiments in accordance with FIG. 3 and FIG. 8 are mutually interchangeable, that is to say that the rest of the features described are correspondingly applicable.

If the seal carrier 30 is situated in the coupling position K, the valve can be operated like a conventional pendulum valve. The valve plate 7 can be pivoted by means of the drive 7 between the open position O, FIG. 1, and an intermediate position by the transverse movement x. In the intermediate position, the valve plate 5 with the closure side 6 covers the valve opening 2, is arranged in a position spaced apart and opposite with respect to the valve seat 4 and reduces the valve opening 2, such that the flow path F is partly interrupted. By means of the perpendicular movement y of the drive 7, the valve plate 7 can be adjusted between said intermediate position and the gas-tight closed position C, FIGS. 3 and 8.

One advantage of this conventional operating mode in which the seal carrier 30 is situated in the coupling position K is that the valve can be closed in a gas-tight manner. In many areas of application, however, complete closing of the valve is required only occasionally, since the valve is principally in the so-called regulating mode, in which the opening cross section is intended to be reduced or enlarged, but not completely closed. In the regulating mode, the first seal 31 in the coupling position K of the seal carrier 30 is continuously exposed chemically and mechanically to the medium flowing through the valve, such that increased wear of the first seal 31 would occur. Therefore, the invention provides for the seal carrier 30 to be able to be decoupled from the valve plate 5 and coupled to the parking section 8 of the valve housing 1 and to assume the parked position P.

According to the invention, the seal carrier 30, in the coupling position K of the seal carrier 30, can be coupled to, and decoupled from again, a first receptacle 21 of the valve plate 5 on the valve plate 5 and, in the parked position P of the seal carrier 30, can be coupled to, and decoupled from again, a second receptacle 22 of the parking section 8 in the parking section 8 of the valve housing 1. In order to enable the releasable coupling in the first receptacle 21 and in the second receptacle 22, the valve has coupling means 33 and 34 assigned to the respect receptacles 21 and 22.

By means of first coupling means 33, the seal carrier 30 can be releasably coupled to the first receptacle 21 of the valve plate 5 and can thus be releasably fixed in the coupling position K. By means of second coupling means 34, the seal carrier 30 can be releasably coupled to the second receptacle 22 of the parking section 8 and can thus be releasably fixed in the parked position P.

The first receptacle 21 of the valve plate 5 is embodied as a translational first receptacle 21, as shown in FIGS. 3, 4a, 4c, 4d, 6 and 7. That is to say that the seal carrier 30 is received into the first receptacle 21 by means of a rectilinear movement of the valve plate 5. The seal carrier 30 can be guided by the perpendicular movement y into the first receptacle 21 into the coupling position K and out of the receptacle 21 from the coupling position K, see FIGS. 4c and 4d. In order to hold the seal carrier 30 in the first receptacle 21 and thus in its coupling position K, the first coupling means 33 are provided, which are embodied as force-locking first coupling means 33, as illustrated in FIG. 6. The force-locking first coupling means 33 hold the seal carrier 30 in the first receptacle 21 in the coupling position K with a holding force until the holding force is overcome, wherein the holding force can be overcome by the perpendicular movement y out of the receptacle 21 for the purpose of decoupling by means of the drive 7. In the exemplary embodiment shown in FIG. 6, said force-locking first coupling means are embodied as a spring-loaded latch 33 arranged in the seal carrier 30. The first receptacle 21 is formed by a multiplicity of fingers 21 arranged all around the seal carrier 30 on the valve plate 5, as can be discerned in FIG. 7, which shows the valve plate 5 without the seal carrier 30. Concave, inwardly facing cutouts 33c are shaped in said fingers 21, see FIGS. 6 and 7. A number of spring-loaded latches 33 corresponding to the number of fingers 21 and of cutouts 33c are situated in the seal carrier 30. Said spring-loaded latches 33 are composed in each case of a spring 33a and a ball 33b to which force is applied by the spring 33a. The ball 33b has a form corresponding to the cutout 33c and is pressed by the spring 33a upon insertion of the seal carrier 30 into the first receptacle 21, such that the seal carrier 30 is fixed in a force-locking manner by means of the force-locking first coupling means 33, embodied as spring-loaded latches, in the first receptacle 21. Consequently, the seal carrier 30 is in the coupling position K. The decoupling of the seal carrier 30 from the first receptacle 21 is illustrated in FIGS. 4c and 4d. The seal carrier 30 retained by means of the second coupling means 34 in the parking section 8 is pulled from the first receptacle 21 by the perpendicular adjustment of the valve plate 5 by means of the upwardly effected perpendicular movement y, illustrated by the arrow in FIG. 4d, by the drive 7 by means of the holding force of the spring-loaded latches 33 being overcome. This is illustrated by the transition from FIG. 4c to FIG. 4d. The coupling of the seal carrier into the coupling position K is effected in the reverse order. The described first receptacle 21 and the first coupling means 33 therefore make it possible to release the seal carrier 30 retained on the valve housing 1—in a manner explained below—from its coupling position K from the valve plate 5 by the perpendicular movement y of the drive 7.

In order that the seal carrier 30 can be releasably fixed in its parked position P on the valve housing in the protected parking section 8, the second receptacle 22 and the second coupling means 34, shown in FIGS. 4a to 5c, are provided.

A protective surface 12 is shaped in the parking section 8 of the valve housing 1, said protective surface substantially corresponding to the form of the first seal 31 of the seal carrier 30. Said protective surface 12 is shaped as a ring-shaped groove in the parking section 8 of the valve housing 1, said groove facing upwardly in the direction toward the closure side 6 at the closing surface 13, as can be discerned in FIG. 2. In FIG. 2, the covering of the parking section 8 has largely been removed, as a result of which the protective surface 12 situated in the interior of the valve can be discerned.

Moreover, the second receptacle 22 is shaped in the parking section 8. Said second receptacle 22, by means of which the seal carrier 30 can be received in the parking section, also forms part of second coupling means 34 on account of its advantageous configuration. All around the protective surface 12, four lead-ins 42 are shaped in the parking section 8, as can be discerned in FIGS. 2, 5a and 5b. Said four lead-ins 42 each undergo transition to a slot 41 extending along the direction of the transverse movement x, see FIG. 1. The lead-ins 42 functionally form the second receptacle 22.

In a manner corresponding to the four lead-ins 42 and slot 41, four knobs 43 are arranged on the seal carrier, see FIGS. 4a, 5a and 5b. The knobs 43 of the seal carrier 30 can be inserted into the lead-ins 42 by the perpendicular movement y of the drive 7. The insertion is illustrated by the transition from FIGS. 4a to 4b and from FIG. 4b to FIG. 4c. If the knobs 43 of the seal carrier 30 have been inserted into the lead-ins 43 by the perpendicular movement y of the drive 7, FIGS. 4c and 5a, said knobs 43 can be guided by means of the drive 7 by the transverse movement x into the slot 41 and thus into an undercut region, as shown by the transition from FIG. 5a to FIG. 5b. In said undercut region, the seal carrier 30 is retained in the direction of the perpendicular movement y. If the drive 7 is then adjusted in the direction of the perpendicular movement y, as described above and shown in FIG. 4d, the seal carrier 30 cannot take part in this perpendicular movement y, but rather remains fixed in the second receptacle 22. Consequently, the seal carrier 30 is detached from the valve plate 5 and from the first receptacle 21, since the force-locking first coupling means 33 release the connection between seal carrier 30 and valve plate 5. The state in which the seal carrier 30 is situated in said undercut region is the parked position P.

In other words, the second coupling means 34 are embodied as a bayonet catch comprising four slots 41, each having a lead-in 42, in the parking section 8 and four knobs 43 on the seal carrier 30. The bayonet catch is arranged and embodied in such a way that the four knobs 43 can be inserted by the perpendicular movement y into the lead-in 42 and can be guided by the transverse movement x into the four slots 41. The seal carrier 30 can thus be brought into the parked position P. The second receptacle 22 of the parking section 8 is therefore embodied in such a way that the seal carrier 30 can be guided at least partly by the perpendicular movement y into the second receptacle 22 into the parked position P and out of the second receptacle 22 from the parked position (P). The coupling and decoupling of the seal carrier 30 into and out of the coupling position K and parked position P are effected at least partly by the perpendicular movement y and by the transverse movement x. In the exemplary embodiment shown, therefore, the first coupling means 33, the first receptacle 21, the second coupling means 34 and the second receptacle 22 are embodied in such a way that the coupling of the seal carrier 30 in the coupling position K and the parked position P and the decoupling are effected by movement of the valve plate 5 by means of the drive 7.

In the parked position P of the seal carrier 30, the first seal 31 is surrounded by the protective surface 12 for the protection of the first seal 31 against the medium flowing along the flow path F. Consequently, in the parked position P, the first seal 31 is protected against chemical and abrasive and other mechanical influences. In this operating mode, the valve can then be operated in the so-called regulating mode, wherein the valve plate 5 with the closing surface 13 thereof readily enables substantial closing, but not fully gas-tight closing of the valve opening 2 by the adjustment of the valve plate 5 by the transverse movement x and the perpendicular movement y by means of the drive 7. FIG. 7 shows the valve plate 5 without the seal carrier 30, which is situated in the parked position P in the parking section 8. As can be discerned, even without the seal carrier 30, it is possible to close the valve opening 2 by the closing surface 13 bearing on the valve seat 4, but gas-tight sealing is not ensured on account of the absent seal. However, this is not actually necessary during a large portion of the use time of the valve in many applications.

The valve shown additionally has an integrated control device 50 for the drive 7, shown in FIG. 1. Said control device 50 is connected to the drive 7 and is embodied in such a way that the valve can be operated in a first operating mode and a second operating mode. In the first operating mode, the seal carrier 30 is arranged in the parked position P and the valve plate 5 is adjustable between the open position 0 and an intermediate position, in which the valve plate 5 with the closure side 6 at least partly covers the valve opening 2, is arranged in a position spaced apart and opposite with respect to the valve seat 4, and in which the valve plate 5 reduces the valve opening 2 and partly interrupts the flow path (F). In the second operating mode, the seal carrier 30 is arranged in the coupling position K, and the valve plate 5 is adjustable between the open position O and the closed position C. The coupling of the seal carrier 30 in the coupling position K and the parked position P and the decoupling, that is to say the transition from one operating mode to the other is effected by the driving of the drive 7 for adjusting the valve plate 5 in the manner described above.

The specific exemplary embodiments explained and illustrated in FIGS. 1 to 7 and FIG. 8 serve merely for the exemplary illustration of the invention on the basis of schematic illustrations. It goes without saying that the invention is not restricted to these exemplary embodiments and the combinations of features thereof. Thus, by way of example, within the scope of the invention it is also possible for the closing surface 13 to be arranged on the seal carrier 30 and for there to be direct gas-tight contact between the first seal 31 and the closing surface 13. In this case, the seal carrier 30 has a plate-shaped cross section, in particular. Such an embodiment is illustrated in FIG. 9. A second seal can be dispensed with in this case. The rest of the features correspond to those in the previous exemplary embodiments. Moreover, it is possible to implement the features that are to be understood functionally in the form of a single element comprising these functional features, and vice versa. It is thus possible, for example, for the first receptacle 21 of the valve plate 5 to be formed by the at least partly radially outwardly facing outer surface 9 of the closing surface 13 and for the force-locking first coupling means 33 to be formed by the sealing means 31 or 32, in particular by the second seal 32 from the first exemplary embodiment in accordance with FIGS. 1 to 7 or the first seal 31 from the second exemplary embodiment in accordance with FIG. 8. The seals 31 and respectively 32 are elastic in a radial direction, such that said sealing means 31 and respectively 32 elastically enclose the outer surface 9 of the closing surface 13 in the coupling position K in such a way that the seal carrier 30 can be releasably fixed in the coupling position K. In this case, the first coupling means 33 described in FIG. 6 and the first receptacle 21 can be obviated. The rest of the features can remain unchanged.

1. A valve for interrupting a flow path in a substantially gas-tight manner, comprising
a valve housing,
a valve opening in the valve housing for the flow path having an opening axis,
a valve seat enclosing the valve opening,
a valve plate having a closure side,
at least one drive by means of which the valve plate is pivotable or displaceable between
an open position, in which the valve plate is positioned in a parking section of the valve housing, said parking section being arranged laterally alongside the valve opening and releases the valve opening and the flow path, and
a closed position, in which
the valve plate covers the valve opening with a closing surface arranged on the closure side,
a first seal touches the valve seat in a gas-sealing manner, and
the valve plate closes the valve opening in a gas-tight manner and interrupts the flow path,
by means of a transverse movement effected at least in part transversely with respect to the opening axis,
characterized by
a seal carrier, which
in a coupling position of the seal carrier can be coupled to, and decoupled again from, a first receptacle of the valve plate on the valve plate and
in a parked position of the seal carrier can be coupled to, and decoupled again from, a second receptacle of the parking section in the parking section of the valve housing,
wherein
the first seal is arranged on the seal carrier in such a way that the first seal touches the valve seat in a gas-sealing manner in the coupling position and in the closed position, wherein there is a gas-tight connection between the first seal and the closing surface at least in the coupling position and in the closed position,
the valve has first coupling means, by means of which the seal carrier can be releasably coupled to the first receptacle of the valve plate and thus fixed in the coupling position, and
the valve has second coupling means, by means of which the seal carrier can be releasably coupled to the second receptacle of the parking section and thus fixed in the parked position.

2. The valve as claimed in claim 1, wherein
the first coupling means, the first receptacle, the second coupling means and the second receptacle are embodied in such a way that the coupling of the seal carrier in the coupling position and the parked position and the decoupling are effected by movement of the valve plate by means of the drive.

3. The valve as claimed in claim 2, wherein
the drive is embodied in such a way that the valve plate can be moved at least in the open position in the form of a perpendicular movement in a direction perpendicular to the closure side, and
the coupling and decoupling of the seal carrier into and out of the coupling position and parked position are at least partly effected by the perpendicular movement.

4. The valve as claimed in claim 3, wherein
the second receptacle of the parking section is embodied in such a way that the seal carrier can be guided at least partly by the perpendicular movement into the second receptacle into the parked position and from the second receptacle out of the parked position.

5. The valve as claimed in claim 4, wherein
the second coupling means are embodied as a bayonet catch having at least one slot having a lead-in and at least one knob, wherein the bayonet catch is arranged and embodied in such a way that the knob can be introduced by the perpendicular movement into the lead-in and can be guided by the transverse movement into the slot and thus into the parked position.

6. The valve as claimed in claim 3, wherein
the first receptacle of the valve plate is embodied as a translational first receptacle, wherein the seal carrier can be guided by the perpendicular movement into the first receptacle into the coupling position and from the receptacle out of the coupling position.

7. The valve as claimed in claim 6, wherein
the first coupling means are embodied as force-locking first coupling means, which hold the seal carrier in the first receptacle in the coupling position with a holding force until the holding force is overcome, wherein the holding force can be overcome by the perpendicular movement out of the receptacle for the purpose of decoupling by means of the drive.

8. The valve as claimed in claim 7, wherein
the force-locking first coupling means is embodied as a spring-loaded latch arranged in the seal carrier or in the first receptacle.

9. The valve as claimed in claim 1, wherein
the closing surface is arranged on the seal carrier, and
there is a gas-tight contact between the first seal and the closing surface.

10. The valve as claimed in claim 1, wherein
the closing surface is arranged on the valve plate, and
the valve has sealing means, which connect the seal carrier and the closing surface in a gas-sealing manner in the coupling position and in the closed position.

11. The valve as claimed in claim 10, wherein
the sealing means are arranged on an at least partly radially inwardly facing inner surface of the seal carrier in such a way that the sealing means, in the coupling position, enclose an at least partly radially outwardly facing outer surface of the closing surface in a substantially radially gas-sealing manner.

12. The valve as claimed in claim 11, wherein
the closing surface is mounted—in particular resiliently—on the valve plate in a movable manner in a direction perpendicular to the closure side relative to the valve plate and in the coupling position relative to the seal carrier within a movement range, and
the outer surface of the closing surface is dimensioned in such a way that, at least within a partial range of the movement range of the closing surface, it is enclosed in a gas-sealing manner by the sealing means in the coupling position.

13. The valve as claimed in claim 7, wherein
the closing surface is arranged on the valve plate,
the valve has sealing means which connect the seal carrier and the closing surface in the coupling position and in the closed position in a gas-sealing manner, and
the sealing means are arranged on an at least partly radially inwardly facing inner surface of the seal carrier in such a way that the sealing means, in the coupling position, enclose an at least partly radially outwardly facing outer surface of the closing surface in a substantially radially gas-sealing manner,
the first receptacle of the valve plate is formed by the at least partly radially outwardly facing outer surface of the closing surface, and
the force-locking first coupling means are formed by the sealing means, which are elastic in a radial direction, wherein the sealing means elastically enclose the outer surface of the closing surface in the coupling position in such a way that the seal carrier can be fixed releasably in the coupling position.

14. The valve as claimed in claim 10, wherein the sealing means are formed
by a second seal,
which is arranged on an at least partly radially inward facing inner surface of the seal carrier and faces at least partly inwardly in a radial direction, and
which, in the coupling position, encloses an at least partly radially outwardly facing outer surface of the closing surface in a substantially radially gas-sealing manner,
or
by the first seal,
which is arranged in an inner edge section of an at least partly radially inwardly facing inner surface of the seal carrier, and
which touches the valve seat in a gas-sealing manner with a partial section facing in an axial direction in the closed position of the valve plate, and
which, with a partial section facing inwardly at least partly in a radial direction, in the coupling position, encloses an at least partly radially outwardly facing outer surface of the closing surface in a substantially radially gas-sealing manner.

15. The valve as claimed in claim 3, wherein the valve is embodied as one of the following valve types:
pendulum valve, wherein
the valve opening and the valve plate have a substantially round cross section,
the seal carrier has a ring-shaped or plate-shaped cross section,
the transverse movement is a pivoting movement about a pivoting axis running substantially parallel to the opening axis,
the perpendicular movement is a linear movement substantially parallel to the opening axis,
the valve plate is pivotable by the transverse movement by means of the drive between the open position and an intermediate position, in which the valve plate with the closure side at least partly covers the valve opening, and is arranged in a position spaced apart and opposite with respect to the valve seat and in which the valve plate reduces the valve opening and partly interrupts the flow path, and
the valve plate is adjustable by means of the drive between the intermediate position and the closed position by the perpendicular movement;
slide valve, wherein
the valve opening and the valve plate have a substantially rectangular cross section,
the seal carrier has a rectangular frame-like or rectangular closed cross section,
the transverse movement is a linear movement along a pushing axis running substantially perpendicular to the opening axis,
the perpendicular movement is a linear movement substantially parallel to the opening axis,
the valve plate is pivotable by the transverse movement by means of the drive between the open position and an intermediate position, in which the valve plate with the closure side at least partly covers the valve opening, and is arranged in a position spaced apart and opposite with respect to the valve seat and in which the valve plate reduces the valve opening and partly interrupts the flow path, and
the valve plate is adjustable by means of the drive between the intermediate position and the closed position by the perpendicular movement.

16. The valve as claimed in claim 1, comprising a control device, which is connected to the drive and embodied in such a way that the valve can be operated in a first operating mode and a second operating mode, wherein
in the first operating mode, the seal carrier is arranged in the parked position and the valve plate is adjustable between the open position and an intermediate position, in which the valve plate with the closure side at least partly covers the valve opening, and is arranged in a position spaced apart and opposite with respect to the valve seat and in which the valve plate reduces the valve opening and partly interrupts the flow path, and
in the second operating mode, the seal carrier is arranged in the coupling position and the valve plate is adjustable between the open position and the closed position.

17. The valve as claimed in claim 1, wherein, in the parking section, a protective surface is shaped in such a way that the first seal is surrounded by the protective surface—in order to protect the first seal against the medium flowing along the flow path—in the parked position of the seal carrier.
